(19) United States
(12) Patent Application Publication
(10) Pub. No.: US 2025/0263129 A1
(43) Pub. Date: Aug. 21, 2025

(54) WHEEL WELL GUARD FOR A WHEEL WELL OF A VEHICLE AND VEHICLE HAVING THE WHEEL WELL GUARD

(71) Applicant: Schaeffler Technologies AG & Co. KG, Herzogenaurach (DE)

(72) Inventors: Marvin Hofmann, Ettlingen (DE); Manuel Bassler, Seltz (FR); Frank Frietsch, Bühlertal (DE)

(73) Assignee: Schaeffler Technologies AG & Co. KG, Herzogenaurach (DE)

(21) Appl. No.: 18/859,706

(22) PCT Filed: Apr. 12, 2023
(86) PCT No.: PCT/DE2023/100267

§ 371 Date: Oct. 24, 2024

(30) Foreign Application Priority Data
Apr. 27, 2022 (DE) 10 2022 110 234.3

(51) Int. Cl. B62D 25/18

(52) U.S. Cl. CPC B62D 25/186

(57) ABSTRACT

A wheel well guard for a wheel well of a vehicle has a plurality of trim elements, the trim elements being adjustable between a guarding position and a stowed position. An adjusting device is included, the adjusting device being coupled to the trim elements so as to move therewith in order to adjust the trim elements between the guarding position and the stowed position, wherein the trim elements are in the form of concentric lamellae which are disposed around a main axis and which can be adjusted synchronously between the guarding position and the stowed position by the adjusting device in the manner of a central shutter mechanism.

### CROSS-REFERENCE TO RELATED APPLICATIONS

This application is the U.S. National Phase of PCT Appln. No. PCT/DE2023/100267 filed Apr. 12, 2023, which claims priority to DE 10 2022 110 234.3 filed Apr. 27, 2022, the entire disclosures of which are incorporated by reference herein.

### TECHNICAL FIELD

The disclosure relates to a wheel well guard for a wheel well of a vehicle. The disclosure further relates to a vehicle having the wheel well guard.

### BACKGROUND

Partially or fully covered wheel wells for vehicles are known, which serve to reduce drag while the vehicle is driving. In order to ensure steering of the front wheels in certain driving situations, adjustable covers are known which can be changed in terms of their contour via an adjusting device in order to free up additional space when the front wheels are turned.

The publication DE 10 2008 046 314 A1 discloses a wheel well arrangement for a motor vehicle, in particular a passenger car, which has at least one wheel well forming a wheel well cut-out for accommodating a wheel, wherein a guard is provided in the region of the wheel well cut-out, the contour of which can be changed or by means of which the contour of the wheel well cut-out can be changed. An adjusting device is assigned to the guard, by means of which its shape can be adjusted.

### SUMMARY

The disclosure is based on the object of proposing a wheel well guard which is characterized by a simple design and improved actuation behavior.

This object is achieved by a wheel well guard having the features described herein and by a vehicle having the features described herein. Preferred or advantageous embodiments of the disclosure are described in the claims, the following description, and the attached figures.

The subject matter of the disclosure is a wheel well guard which is designed and/or suitable for a wheel well of a vehicle. In particular, the wheel well guard has the function of reducing the drag of the vehicle when the vehicle is driving and protecting the respectively associated vehicle wheel when the vehicle is stationary. In particular, the wheel well serves to accommodate a vehicle wheel, wherein the vehicle wheel can be at least partially guarded and/or is guarded by the wheel well in the direction of travel and in the opposite direction.

The wheel well guard has cover elements which are adjustable between a guarding position and a stowed position. In the guarding position, the wheel well is at least partially guarded by the cover elements, particularly in the transverse direction of the vehicle, and in the stowed position, the cover elements are stowed in the wheel well. In particular, more than 30%, preferably more than 50%, in particular more than 70% of the wheel well and/or the vehicle wheel is guarded in the guarding position in the axial direction with respect to a wheel rotation axis by the cover elements. In particular, the cover elements are largely, for example more than 90%, or completely stowed in the stowed position.

The wheel well guard has an adjusting device which is coupled to the cover elements so as to move therewith in order to adjust the cover elements between the guarding position and the stowed position. In particular, the cover elements can be adjusted relative to the wheel well or the vehicle body by the adjusting device. The adjusting device is preferably designed to convert an electrical signal into a mechanical adjusting movement for adjusting the cover elements. The adjusting device can be connected to a control unit of the vehicle in a signal-transmitting manner for this purpose. In particular, the control unit is designed to actuate the adjusting device depending on a driving situation and/or a vehicle speed and/or a steering angle.

In the context of the disclosure, the cover elements are designed as concentric lamellae arranged around a main axis, which can be adjusted synchronously between the guarding position and the stowed position by the adjusting device in the manner of a central shutter mechanism. In particular, the adjusting device is designed in such a way that when the adjusting device is actuated, the lamellae are moved simultaneously and/or at the same speed from the stowed position to the guarding position and vice versa. In particular, the lamellae are continuously fanned out by the adjusting device, so that in the guarding position a fan covering the wheel well in the axial direction is formed by the lamellae. In this regard, the lamellae can slide against one another with a slight inclination with respect to one another and with mutual contact. The lamellae can, for example, have a crescent-shaped and/or triangular and/or wing-shaped geometry. Preferably, the lamellae are arranged distributed around the main axis in an angular range of more than 120 degrees, preferably more than 180 degrees, in particular more than 240 degrees. In a stationary vehicle state, the main axis can be defined by a wheel rotation axis of the associated vehicle wheel. In particular, the adjusting device essentially works according to the functional principle of a central shutter mechanism of a camera lens, also known as a leaf shutter.

The advantage of the disclosure is that an automatic wheel well guard is proposed based on the function of the central shutter mechanism which is characterized by a high reaction speed. This makes the wheel well guard particularly suitable for an arrangement on the front axle in order to enable the wheel well guard to be opened and closed quickly depending on the driving situation, preferably when the steering wheel is turned. Furthermore, by fanning out the lamellae, a particularly compact wheel well guard can be provided, which is also characterized by a simple actuation.

In a specific embodiment, the adjusting device has an adjusting disc which can be rotated in the direction of rotation about the main axis between a first and a second relative position. In this regard, in the first relative position, the cover elements are arranged in the guarding position and, in the second relative position, they are arranged in the stowed position. In particular, a mechanical interaction occurs between the adjusting disc and the cover elements when the adjusting disc is rotated about the main axis, whereby the cover elements are simultaneously adjusted by means of a pivoting movement and/or sliding movement. Preferably, the cover elements are moved into the stowed position when the adjusting disc is rotated from the first relative position into the second relative position and are moved out into the guarding position when the adjusting disc is rotated from the second relative position into the first relative position. Preferably, the adjusting disc is infinitely adjustable between the two relative positions. In this regard, the first and second relative positions with respect to the main axis are to be understood as two different angular positions of the adjusting disc in each case. For example, the adjusting disc can be rotated between the two relative positions in an angular range of less than 40°, preferably less than 30°, in particular less than 20° about the main axis. The adjusting disc is particularly preferably designed as a circular ring segment, preferably a semi-circular ring segment, arranged coaxially to the main axis. A wheel well guard is thus proposed which is characterized by a particularly simple and space-saving actuation of the cover elements.

In a further more specific embodiment, the cover elements are pivotably fixed at a first connection point in each case and are positively guided at a second connection point in each case in a guide link each formed in the adjusting disc. In particular, the cover elements are, in each case, pivotably mounted at the first connection points about their own pivot axis. Preferably, the pivot axes of the cover elements are aligned axially parallel to one another and/or to the main axis. Alternatively or optionally in addition, the first connection points lie on a common pitch circle around the main axis and/or are evenly spaced apart from one another in the circumferential direction. In particular, the term “pivotably fixed” is to be understood as a pivotable connection of the cover elements about the respective pivot axis, wherein the cover elements are fixed or secured in the axial direction with respect to the main axis or the respective pivot axis. In particular, the second connection points lie on a further common pitch circle around the main axis, the diameter of which varies when the cover elements are adjusted. Preferably, each cover element is pivotably mounted about the respective first connection point and is coupled with the adjusting disc at the second connection point so as to move therewith. In this regard, the cover elements can be guided in the associated guide link via the respective second connection point in such a way that the cover elements are pivoted together, in particular simultaneously, into the stowed position or the guarding position around the respective first connection point depending on the direction of rotation of the adjusting disc. A wheel well guard is thus proposed which is characterized by a simple, in particular simultaneous, actuation of all cover elements.

In a further development, the cover elements are pivotable at the respective first connection point via a pivot bolt and are guided at the second connection point via a guide bolt in each case along a curve in the respectively associated guide link. In particular, the first connection points are in each case defined by the respectively associated pivot bolt and/or lie on the pivot axis defined by the respective pivot bolt. In particular, the second connection points are in each case defined by the respectively associated guide bolt and/or lie on an axis defined by the respective guide bolt, in particular aligned axially parallel to the main axis and/or the pivot axes. The pivot bolts are particularly preferably fixed in the axial direction with respect to the main axis in a housing of the wheel well guard. Particularly preferably, the guide bolts are mounted in a sliding manner along the curve in the respectively associated guide link. The guide links can each be formed by a curved control slot. The adjusting disc is thus coupled to the cover elements in such a way that a rotary movement of the adjusting disc is converted into a pivoting and/or sliding movement of the cover elements. For example, the pivot bolts and/or the guide bolts can each be formed by a cylindrical bolt, in particular a pin or the like.

In a further embodiment, in the guarding position, the cover elements are supported against one another in the axial direction with respect to the main axis at least at a common center point. Preferably, the cover elements are arranged so as to overlap one another in sections, so that in the guarding position a guarding region of the wheel well is guarded by the cover elements completely and/or in a gap-free manner and/or over the entire surface. In particular, each of the cover elements is arranged in a separate plane, wherein the cover elements are each supported against one another in an overlapping region such as to contact the immediately adjacent cover element over the entire surface. It is particularly preferable for the center point of the cover elements to lie on the main axis in the guarding position. The axial contact of the cover elements ensures a particularly stable support of the cover elements in the guarding position.

In a further specific implementation, the wheel well guard has a housing partially surrounding the main axis, wherein the adjusting device and the cover elements are accommodated in the housing. Preferably, the cover elements are largely or completely accommodated in the housing in the stowed position. In particular, the housing protects the adjusting device, preferably its mechanics, from environmental influences such as dust, splash water or the like. The housing can be made up of multiple parts, preferably two parts. For this purpose, the housing has a housing base body that accommodates the adjusting device and the cover elements, as well as a housing cover. In particular, the housing base body is open in an axial direction with respect to the main axis, wherein the housing cover covers or closes the housing base body. In particular, the cover elements can be moved in or out in the radial direction with respect to the main axis between the housing cover and the housing base body. In an installed state, the housing is preferably axially arranged in the axial direction with respect to the main axis between a body component, for example a fender, and a wheel well cover of the wheel well. Preferably, the housing is covered by the body component in an installation situation when viewed in the axial direction with respect to the main axis. A wheel well guard is therefore proposed which is characterized by a robust design. In addition, the wheel well guard can be designed as a pre-assembled structural unit by accommodating the cover elements and the adjusting device in the housing.

In a further embodiment, the adjusting disc is guided within the housing between the two relative positions about the main axis along an inner circumference. Preferably, the adjusting disc is arranged in the radial direction with respect to the main axis between an outside and an inside inner circumference. In this regard, the adjusting disc can run in the radial direction against the inside and/or outside inner circumference, preferably in a sliding manner. The inside and outside inner circumferences extend equidistantly to one another around the main axis, at least in the region where the adjusting disc is in contact. A wheel well guard is thus proposed which is characterized by a particularly compact design as well as a simple and cost-effective embodiment.

In a further development, the adjusting disc is supported on the inside or outside inner circumference of the housing via at least or exactly one guide element. In particular, the adjusting disc is supported by the at least one guide element on the outside or inside inner circumference in a sliding manner in the radial direction with respect to the main axis. The guide element can be designed as a further guide bolt or a guide roller, for example. For example, the adjusting disc can be mounted in a manner sliding or rolling along the inner circumference via the at least one guide element. An adjusting device is thus proposed which is characterized by a stable guidance of the adjusting disc within the housing.

In a further specific embodiment, the adjusting device has an adjusting actuator which is operatively connected to the adjusting disc for transmitting an adjusting movement. In principle, the adjusting actuator can be designed as an electrically and/or magnetically and/or hydraulically actuated adjusting actuator. Preferably, the adjusting actuator is operatively connected to the adjusting disc via an effective contour formed on the adjusting disc. In particular, the effective contour is designed as a toothing extending circumferentially at least in sections, wherein the adjusting actuator engages with the toothing via a gear. Preferably, the adjusting actuator engages with the adjusting disc via a worm gear or a toothed gear. This ensures a particularly robust and simple rotation of the adjusting disc around the main axis.

A further subject matter of the disclosure relates to a vehicle having the wheel well guard as previously described. The vehicle can be designed as a passenger car or as a commercial vehicle. In particular, the vehicle has one of the wheel well guards in each case at least on the front axle, but preferably on each vehicle wheel. It is particularly preferred that the wheel well guards can be actuated independently of one another.

### BRIEF DESCRIPTION OF THE DRAWINGS

Further features, advantages and effects of the disclosure result from the following description of preferred exemplary embodiments and the attached figures. In the figures:

FIG. 1 shows a schematic side view of a front section of a vehicle with a wheel well guard in a guarding position;

FIG. 2 shows the front section of the vehicle in the same representation as FIG. 1 with the wheel well guard in a stowed position;

FIG. 3 shows an axial view of the wheel well guard with the housing open in the guarding position;

FIG. 4 shows the wheel well guard in the same representation as FIG. 3 in the stowed position;

FIG. 5 shows an exploded view of the wheel well guard.

### DETAILED DESCRIPTION

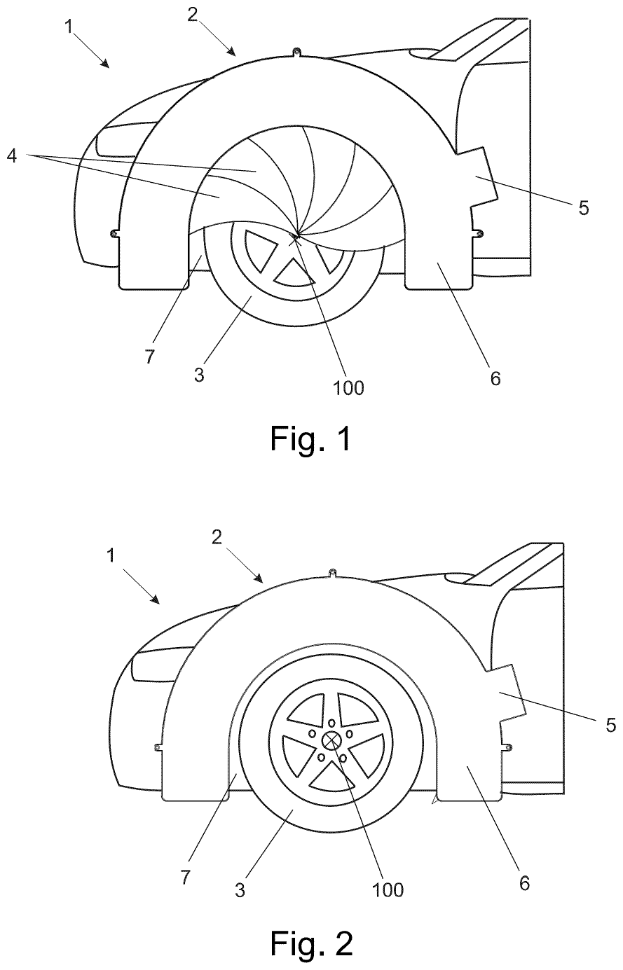

FIGS. 1 and 2 each show a schematic side view of a front section of a vehicle 1 with a wheel well guard 2 in the region of a front vehicle wheel 3 as an exemplary embodiment of the disclosure. The wheel well guard 2 has multiple cover elements 4, which are adjustable between a guarding position, as shown in FIG. 1, and a stowed position, as shown in FIG. 2, by means of an adjusting device 5.

The wheel well guard 2 has a housing 6, wherein the adjusting device 5 and the cover elements 4 are arranged in the housing 6, at least in the stowed position. In this regard, the cover elements 4 are formed as multiple lamellae arranged coaxially to a main axis 100, which can be moved out of the housing 6 into the guarding position and moved into the stowed position in the housing 6 according to the functional principle of a central shutter mechanism. Central shutter mechanisms are known from the field of camera lenses and are used to adjust the incidence of light. Such a mechanism provides the responsiveness required for an automatic wheel well guard 2 in order to allow for rapid opening and closing. This makes the wheel well guard 2 particularly suitable for use on the front vehicle wheels 3 in order to be able to quickly adjust the cover elements 4 when the steering wheel is turned, for example.

In the guarding position, the cover elements 4 are supported in an overlapping manner in relation to one another, so that a wheel well 7 accommodating the vehicle wheel 3 is guarded in some regions in the axial direction with respect to the main axis 100. For example, at least 50% of the wheel well 7 and/or the vehicle wheel 3 is guarded by the cover elements 4 in the guarding position. This ensures an optimized air flow and thus a reduced cd value.

When the vehicle is stationary, the main axis 100 can be defined by the wheel axle of the vehicle wheel 3, for example. For example, the housing 6 can be arranged in the axial direction with respect to the main axis 100 between the fender and a covering of the wheel well 7.

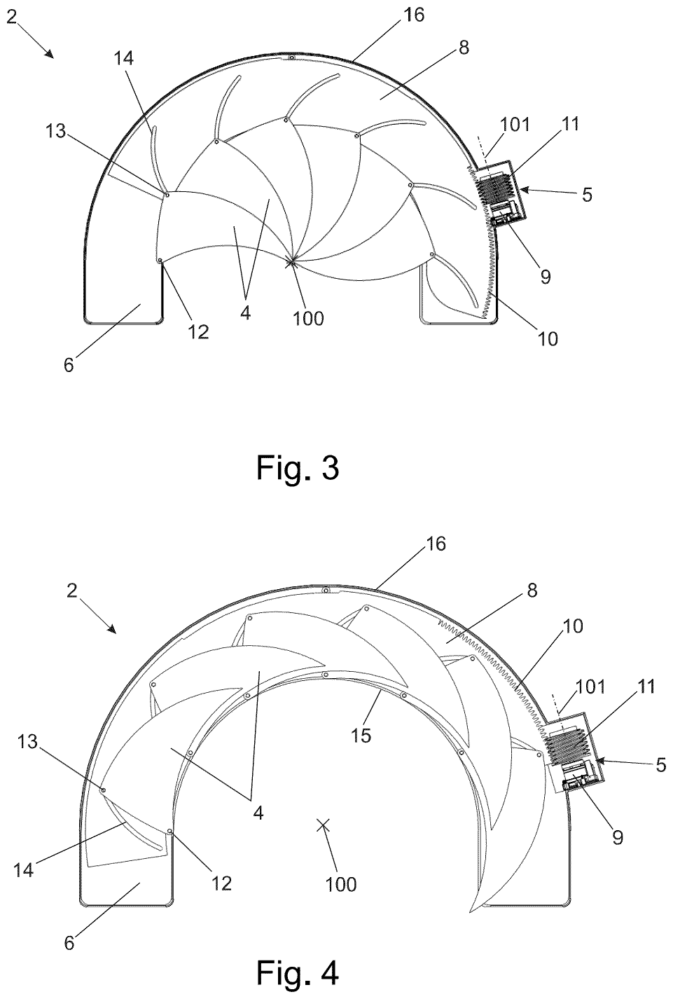

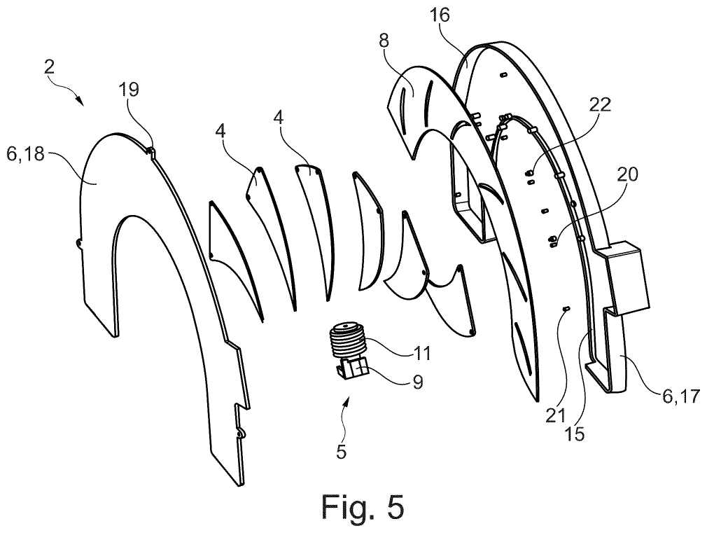

FIGS. 3 and 4 each show the wheel well guard 2 in an axial view with respect to the main axis 100 with the housing 6 open. The adjusting device 5 has an adjusting disc 8 and an adjusting actuator 9, which is used to drive the adjusting disc 8 about the main axis 100. For this purpose, the adjusting disc 8 has, in sections, an effective contour 10 in the form of a toothing on its outer circumference, wherein the adjusting actuator 9 engages with the effective contour 10 via a worm shaft 11. The adjusting actuator 9 is designed as an electric motor which drives the worm shaft 11 about an axis of rotation 101, wherein the axis of rotation 101 is arranged tangentially to an outer circumference of the adjusting disc 8. This enables a particularly compact arrangement of the adjusting actuator 9.

The adjusting disc 8 is designed as a semi-circular ring segment, which can be rotated within the housing 6 in the direction of rotation about the main axis 100 between a first and a second relative position. In the first relative position, as shown in FIG. 3, the cover elements 4 are arranged in the guarding position and in the second relative position, as shown in FIG. 4, the cover elements 4 are arranged in the stowed position. The adjusting disc 8 can be rotated, for example, in an angular range of approximately 30° about the main axis 100 between the two relative positions.

The cover elements 4 are pivotably fixed to the housing 6 at a first connection point 12 in each case and are positively guided at a second connection point 13 in each case in a guide link 14 each arranged in the adjusting disc 8. In this regard, a rotation of the adjusting disc 8 about the main axis 8 causes the cover elements 4 to be moved in or out together and synchronously via a pivoting and sliding movement in the radial direction with respect to the main axis 100 depending on the direction of rotation.

The cover elements 4 are each arranged so as to overlap one another in different planes and slide against one another in an overlapping region when the adjusting disc 8 is moved. The cover elements 4, in particular when viewed in the guarding position, are each designed to taper in a substantially crescent shape in the direction of the main axis 100, starting from the associated connection points 12, 13 in each case. As a result, the cover elements 4 can be supported against one another axially with respect to the main axis 100 in the overlapping region in the guarding position and can be accommodated completely and in a particularly space-saving manner within the housing 6 in the stowed position. Due to the crescent-shaped design, the cover elements 4 can be arranged in the stowed position close to the contour of an inner circumference 15 of the housing 6 or the wheel well 7, as shown in FIG. 2.

FIG. 5 shows an exploded view of the wheel well guard 2. The housing 6 is formed of two parts, wherein the housing 6 has a housing base body 17 that is open in the axial direction and a housing cover 18 that closes the housing base body 17. The adjusting device 5 is accommodated within the housing base body 17, wherein the cover elements 4 can move in or out between the housing base body 17 and the housing cover 18 in the radial direction. The housing cover 18 is, for example, screwed to the housing base body 17. The housing cover 18 can also have multiple connection interfaces 19 on the circumference, for example fixing brackets, which are used to mount the wheel well guard 2 on the vehicle 1. The housing cover 18 protects the adjusting device 8 from environmental influences and closes off the system.

The cover elements 4 are each pivotably fixed to the housing base body 17 at the first connection point 12 via a pivot bolt 20 in each case and are guided in the respectively associated guide link 14 at the second connection point 13 via a guide bolt 21 in each case. As shown in FIGS. 3 and 4, the guide links 14 are designed as curved guide slots, whereby the guide bolts 21 are positively guided along a curved path in the guide links 14 when the adjusting disc 8 is rotated about the main axis 100.

The adjusting disc 8 is supported in the radial direction on the inside and/or outside inner circumference 15, 16 of the housing base body 17, wherein the adjusting disc 8 is guided along the inside and/or outside inner circumference 15, 16 during a rotation between the two relative positions. For this purpose, the adjusting disc 8 can be supported or mounted on the inside or outside inner circumference 15, 16 via one or more guide elements 22. For example, the guide elements 22 can be designed as guide bolts mounted in a sliding and/or rotatable manner.

For example, the adjusting actuator 9 is connected to a control unit of the vehicle 1 in a signal-transmitting manner, wherein the electric motor is actuated based on a control signal output by the control unit. In this regard, the electric motor is energized on the basis of the control signal and drives the worm shaft 11, which causes the adjusting disc 8 to rotate about the main axis 100 via the effective contour 10, thereby simultaneously moving the cover elements 4 in or out. For example, the control signal is generated on the basis of a steering angle and/or a vehicle speed and/or an operating condition and/or a driving situation and/or by manual actuation.

### List of Reference Signs

1 Vehicle
2 Wheel well guard
3 Vehicle wheel
4 Cover elements
5 Adjusting device
6 Housing
7 Wheel well
8 Adjusting disc
9 Adjusting actuator
10 Effective contour
11 Worm shaft
12 First connection point
13 Second connection point
14 Guide link
15 Inside inner circumference
16 Outside inner circumference
17 Housing base body
18 Housing cover
19 Connection interfaces
20 Pivot bolt
21 Guide bolt
22 Guide element
100 Main axis
101 Axis of rotation

1. A wheel well guard for a wheel well of a vehicle, comprising:
multiple cover elements, wherein the cover elements are adjustable between a guarding position and a stowed position,
an adjusting device, wherein the adjusting device is coupled to the cover elements so as to move therewith in order to adjust the cover elements between the guarding position and the stowed position,
wherein the cover elements are designed as concentric lamellae arranged around a main axis, which can be adjusted synchronously between the guarding position and the stowed position by the adjusting device in a manner of a central shutter mechanism.

2. The wheel well guard according to claim 1, wherein the adjusting device has an adjusting disc which can be rotated about the main axis between a first and a second relative position, wherein, in the first relative position, the cover elements are arranged in the guarding position and wherein, in the second relative position, they are arranged in the stowed position.

3. The wheel well guard according to claim 2, wherein each of the cover elements is pivotably fixed at a first connection point in each case and is positively guided at a second connection point in each case in a guide link each formed in the adjusting disc.

4. The wheel well guard according to claim 3, wherein the cover elements are pivotable at the respective first connection point via a pivot bolt and are guided at the second connection point via a guide bolt in each case along a curve in the respectively associated guide link.

5. The wheel well guard according to claim 1, wherein, in the guarding position, the cover elements are supported against one another in an axial direction with respect to the main axis at least at a common center point.

6. The wheel well guard according to claim 2, further comprising a housing partially surrounding the main axis, wherein the adjusting device and the cover elements, at least in the stowed position, are accommodated in the housing.

7. The wheel well guard according to claim 6, wherein the adjusting disc is guided within the housing between the two relative positions about the main axis along an inner circumference of the housing.

8. The wheel well guard according to claim 7, wherein the adjusting disc is supported on the inner circumference of the housing via at least one guide element.

9. The wheel well guard according to claim 2, wherein the adjusting device has an adjusting actuator, wherein the adjusting actuator is operatively connected to the adjusting disc for transmitting an adjusting movement.

10. A vehicle having the wheel well guard according to claim 1.
